(19) United States
(12) Patent Application Publication
(10) Pub. No.: US 2012/0101829 A1
(43) Pub. Date: Apr. 26, 2012

(54) WHOLESALE DEVICE REGISTRATION SYSTEM, METHOD, AND PROGRAM PRODUCT

(75) Inventor: David Jason Hunt, Kirkwood, MO (US)

(73) Assignee: International Business Machines Corporation, Armonk, NY (US)

(21) Appl. No.: 12/910,118

(22) Filed: Oct. 22, 2010

(51) Int. Cl. G06Q 99/00

(52) U.S. Cl. 705/1.1

(57) ABSTRACT

Aspects of the disclosure provide a computerized wholesale device registration system comprising: a registration framework for: obtaining a wholesale device initiation request including: identification of an initiating device; and wholesale device identification information; querying a device database to determine capabilities of the initiating device; selecting a registration completion plug-in based upon the initiation request and the capabilities of the initiating device; and initiating the registration completion plug-in to register the wholesale device with a subscriber account system.

### BACKGROUND

The disclosure relates generally to registering wholesale devices to a service provider account. More particularly, the disclosure relates to a registration framework, a method and a program product for registering wholesale devices to a service provider subscriber account.

As the communications industry expands, service providers are connecting a broader spectrum of devices to their networks beyond traditional cell phones and smart phones. For example, service providers are beginning to connect “emerging” devices such as e-readers, smart utility meters, digital picture frames, and automobiles to their networks.

Traditionally, service providers use a wholesale business model in connecting these emerging devices. That is, the device developer typically markets and sells the device directly to the consumer (and in some cases, may later provide periodic billing to the consumer), while the service provider activates the device on the network and bills the device developer. In these cases, the service provider does not know the customer (e.g., the service provider does not have a customer-based relationship with the customer). That is, the service provider cannot tell whether the customer using this emerging device is also a subscriber to one or more of the service provider's other services (e.g., mobile phone services, netbook services, etc.).

### SUMMARY

A first aspect of the disclosure provides a computerized wholesale device registration system comprising: a registration framework for: obtaining a wholesale device initiation request including: identification of an initiating device; and wholesale device identification information; querying a device database to determine capabilities of the initiating device; selecting a registration completion plug-in based upon the initiation request and the capabilities of the initiating device; and initiating the registration completion plug-in to register the wholesale device with a subscriber account system.

A second aspect of the disclosure provides a method for registering a wholesale device to a service provider subscriber account, the method comprising: receiving a request for registration of a wholesale device from an initiating device; determining whether the initiating device is the wholesale device or another registration device; requesting wholesale device identification information in the case that the initiating device is the another registration device; determining capabilities of the initiating device using a wholesale device database or a direct device database; and authenticating the wholesale device and a subscriber associated with the wholesale device using the wholesale device identification information and the capabilities of the initiating device.

A third aspect of the disclosure provides a computer program comprising program code embodied in at least one computer readable storage medium, which when executed, enables a computer system to implement a method for registering a wholesale device to a service provider subscriber account, the method comprising: receiving a request for registration of a wholesale device from an initiating device; determining whether the initiating device is the wholesale device or another registration device; requesting wholesale device identification information in the case that the initiating device is the another registration device; determining capabilities of the initiating device using a wholesale device database or a direct device database; and authenticating the wholesale device and a subscriber associated with the wholesale device using the wholesale device identification information and the capabilities of the initiating device.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a computational system suited for enablement of the disclosed methodology.

FIG. 2 shows a flow diagram of one set of steps consistent with the disclosed methodology and process used in embodiments.

It is noted that the drawings of the disclosure are schematic in nature and not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

The disclosure provides solutions for registering a wholesale device to a service provider subscriber account. That is, aspects of the disclosure provide solutions for both authenticating a subscriber and determining that a device to be registered belongs to the subscriber. In contrast to current approaches, registering a wholesale device to a service provider subscriber account may give the service provider a more comprehensive view of multiple devices used by a subscriber on the network. This comprehensive view may allow the service provider to improve services to the subscriber, more effectively target advertising or promotions to the subscriber, determine a profitability score for the subscriber across all the subscribers' devices, etc.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer readable medium(s) may be utilized. The computer readable medium may be a computer readable storage medium or a computer readable signal medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be any tangible medium that can contain or store a program for use by or in conjunction with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer (or, device), as a stand-alone software package, partly on the user's computer (or, device) and partly on a remote computer or entirely on the remote computer or server. In the latter scenario, the remote computer may be connected to the user's computer (or, device) through any type of network, including a local area network (LAN) or a wide area network (WAN), or the connection may be made to an external computer (for example, through the Internet using an Internet Service Provider)

The present disclosure is described below with reference to flowchart illustrations and/or block diagrams of methods, apparatus (systems) and computer program products according to embodiments taught herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

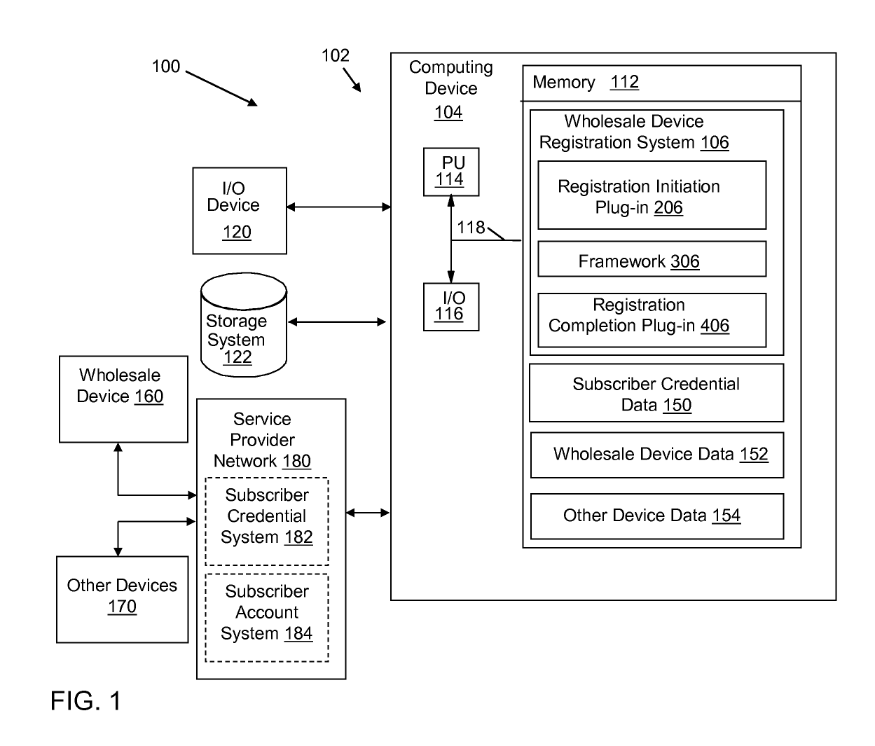

Referring now to FIG. 1 there is depicted an illustrative environment 100 including a system for registering a wholesale device to a service provider subscriber account. To this extent, environment 100 includes a computer infrastructure 102 that can perform the various process steps described herein for registering a wholesale device to a service provider subscriber account. In particular, computer infrastructure 102 is shown including a computing device 104 that comprises a wholesale device registration system 106, which enables computing device 104 to implement a method of registering a wholesale device to a service provider subscriber account by performing the process steps of the disclosure. It is understood that one or more components of wholesale device registration system 106 may be managed or held by a service provider. In one embodiment, components of wholesale device registration system 106 may be located within a service provider network 180, however, in some embodiments, wholesale device registration system 106 may be partially located outside of service provider network 180.

It is understood that as used herein, the term “service provider” describes an entity that provides connectivity and service to e.g., a mobile phone and/or internet network. Service providers may traditionally provide mobile services (e.g., smart phone, netbook or other services) to a variety of other devices 170. Traditionally, these service providers do not have a customer-type relationship to wholesale devices 160 (e.g., the user of the wholesale device 160 does not pay the service provider directly for the wholesale device 160), even though these service providers may supply the network connectivity used by many of these wholesale devices 160.

Computing device 104 is shown including a memory 112, a processor (PU) 114, an input/output (I/O) interface 116, and a bus 118. Further, computing device 104 is shown in communication with an external I/O device/resource 120, a storage system 122, a service provider network 180, a wholesale device 160 (via service provider network 180), and another device 170 (via service provider network 180). As is known in the art, in general, processor 114 executes computer program code, such as that for a wholesale device registration system 106, that is stored in memory 112 and/or storage system 122. While executing computer program code, processor 114 can read and/or write data, such as subscriber credential data 150, wholesale device data 152 and/or other device data 154, to/from memory 112, storage system 122, and/or I/O interface 116 (which may be connected to one or more devices, e.g., a wholesale device 160 and/or another device 170, such as a smartphone, netbook, message phone, other computer, etc.). Bus 118 provides a communications link between each of the components in computing device 104. I/O device 120 can comprise any device that enables a user to interact with computing device 104 or any device that enables computing device 104 to communicate with one or more other computing devices such as a graphical user interface (GUI), a touch-screen or other display. Input/output devices (including but not limited to keyboards, displays, pointing devices, touch screens, etc.) can be coupled to the system either directly or through intervening I/O controllers.

In any event, computing device 104 can comprise any general purpose computing article of manufacture capable of executing computer program code installed by a user (e.g., a personal computer, server, handheld device, etc.). However, it is understood that computing device 104 and wholesale device registration system 106 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

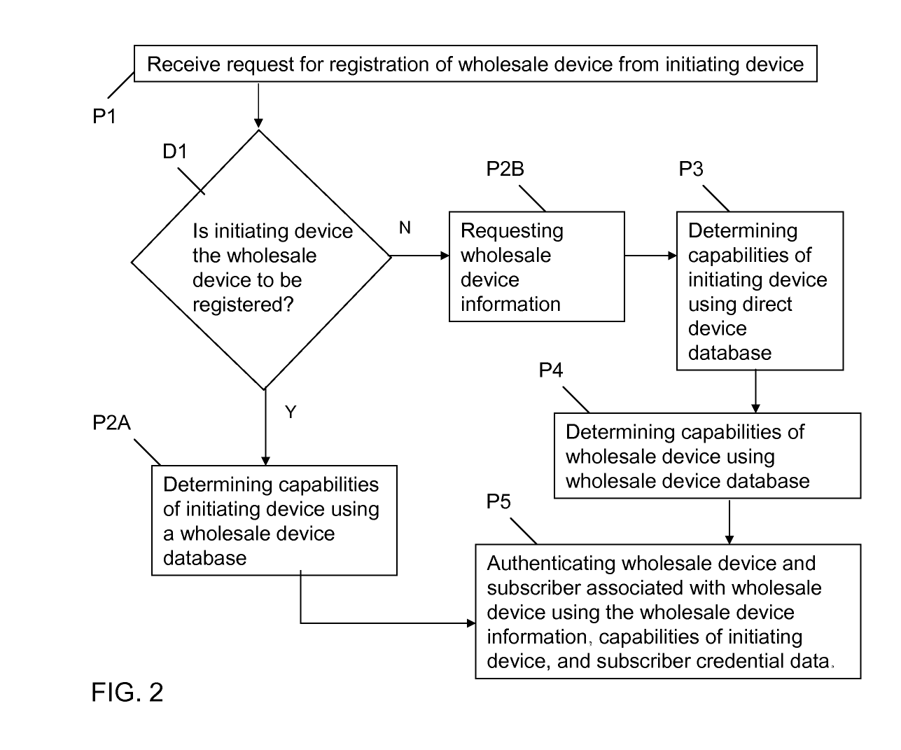

FIG. 2 depicts a process flow diagram in accordance with an embodiment. In process P1, wholesale device registration system 106 may receive a request for registration of a wholesale device 160 from an initiating device. It is understood that requests for registration of wholesale device 160 may be initiated from either the wholesale device 160 itself, or another device 170 capable of interacting with wholesale device registration system 106. For example, in one embodiment, other device 170 may include a device with an already existing service provider relationship. That is, other device 170 may include a smartphone, a netbook, a message phone, or another device connected to a service provider network 180. In another embodiment, the term “other device” may include devices, mechanisms, or channels without traditional service provider relationships (or, intermediary device). For example, in this case, the other (or, intermediary) device could include: a system capable of connecting a user to the internet (e.g., any user interface connecting to a website), a system capable of transmitting or receiving a voice call (e.g., an interactive voice response system, a voice-over internet protocol system), or a system capable of transmitting or receiving a text message (e.g., a customer service request system)

In any case, the request for registration of wholesale device 160 may be received by wholesale device registration system 106, and more specifically, may be handled by the registration initiation plug-in 206.

In decision D1, registration initiation plug-in determines whether the initiating device is a wholesale device 160 or another device 170. In the case that the initiating device is a wholesale device 160 (Yes to D1), then process P2A includes determining capabilities of the initiating device by using wholesale device data 152 (from a wholesale device database). The framework 306 may provide the functionality of process P2A by retrieving wholesale device data 152 from a wholesale device database. This wholesale device data 152 may include, for example, the data format and data transfer capabilities of the wholesale device 160. The wholesale device data 152 may include data about the capabilities of wholesale device 160, including: data transfer capabilities (e.g., one-way in, one-way out, two-way), device input capabilities (e.g., via a keyboard, numeric pad, touch screen, etc.) and display capabilities (e.g., display size, display only, etc.).

In the case that the initiating device is not a wholesale device (e.g, it is another device 170), in process P2B, the registration initiation plug-in 206 may prompt a user to provide information regarding the type of wholesale device to be registered. In this embodiment, a user may be attempting to register a wholesale device (e.g. an e-reader, a smart energy meter, a digital picture frame, etc.) through a website on their personal computer or an application on their smart phone. In order to determine the capabilities of that wholesale device, registration initiation plug-in 206 may prompt a user to provide that data.

After determining the type of wholesale device 160 attempting to be registered via another device 170, in step P3, framework 306 may determine the capabilities of the initiating device (other device 170) by checking an other device database for other device data 154. The other device data 154 may include data about the capabilities of other device 170, including: data format capabilities, data transfer capabilities (e.g., one-way in, one-way out, two-way), device input capabilities (e.g., via a keyboard, numeric pad, touch screen, etc.) and display capabilities (e.g., display size, light-emitting diode only, etc.) of other device 170. Further, where wholesale device registration system 106 is at least partially located within the service provider network 180, other device data 154 may be stored locally and may be easily retrieved.

In process P4, framework 306 may determine capabilities of the wholesale device by using the wholesale device data 152 (from a wholesale device database) obtained in process P2B. As indicated above, this wholesale device data 152 may include, for example, the data format and data transfer capabilities (e.g., one-way in, one-way out, two-way), device input capabilities (e.g., via a keyboard, numeric pad, touch screen, etc.) and display capabilities of the device (e.g., display size, light-emitting diode only, etc.).

In any case, in process P5, the registration completion plug-in 406 authenticates the wholesale device 160 and a subscriber (e.g., a user) associated with wholesale device 160. Registration completion plug-in 406 may authenticate the wholesale device 160 using wholesale device information and capabilities of the initiating device (derived from, e.g., wholesale device data 152 or other device data 154). Where additional information or instructions are required to authenticate the wholesale device 160, registration completion plug-in 406 may send instructions to a user via framework 306, and subsequently, registration initiation plug-in 206. Further, registration completion plug-in 406 may authenticate the user separately from authenticating the wholesale device 160. For example, registration completion plug-in 406 may authenticate the user after obtaining subscriber credential data 150 (e.g., from a subscriber credential system 182) and comparing that subscriber credential data 150 with the initiating device information to determine whether the user is associated with the initiating device (where associations between users and devices may be contained in, e.g. a subscriber account system 184). After authenticating the wholesale device and the user, registration completion plug-in 406 may communicate one or more authentication messages (e.g., authentication tokens) to the service provider network 180, where the authentication messages indicate that the wholesale device belongs to the authenticated user. These authentication messages sent by registration completion plug-in 406 may be used to update the subscriber account system 184. As is explained further with reference to the examples herein, the wholesale device 160 may be authenticated separately (from the initiating device), to determine that the wholesale device 160 is in the possession of the authenticated user.

Further details of the systems and methods described herein will be explained in conjunction with the following example scenarios, in which a user attempts to authenticate a wholesale device 160 to a service provider network 180.

### EXAMPLE 1

Process (a): a user goes to service provider web site (via other device 170) and requests to register a wholesale device 160.

Process (b): Registration initiation plug-in 206 prompts the user for the wholesale device type.

Process (c): Registration initiation plug-in 206 provides request initiation information to framework 306.

Process (d): Framework 306 checks the device database to determine wholesale device capabilities (wholesale device data 152) and initiating device capabilities (other device data 154). Framework 306 discovers that the wholesale device 160 has two-way messaging capability.

Process (e): Framework 306 selects and invokes a registration completion plug-in 406 that can handle a request: i) initiated from a service provider web site, and ii) for registering a two-way messaging wholesale device 160.

Process (f): Registration completion plug-in 406 prompts user (via the framework 306 and initiation plug-in 206) for authentication credentials.

Process (g): Registration completion plug-in 406 authenticates user to a subscriber credential system 182 (which may be located within service provider network 180 and/or wholesale device registration system 106).

Process (h): Registration completion plug-in 406 prompts user (via the framework 306 and initiation plug-in 206) for the messaging address of the wholesale device 160.

Process (i): Registration completion plug-in 406 sends a message to the wholesale device 160 asking user for confirmation of the registration.

Process (j): Registration completion plug-in 406 monitors incoming messages for confirmation message from the wholesale device 160. User responds with a confirmation message using wholesale device 160.

Process (k): Once message is received, registration completion plug-in 406 notifies framework 306 of wholesale device 160 details.

Process (l): Framework 306 notifies subscriber account system 184 (e.g., at service provider network 180 and/or wholesale device registration system 106) of new association between the wholesale device 160 and the subscriber's account.

### EXAMPLE 2

Process (a): User goes to service provider web site from wholesale device 160 and requests registration.

Process (b): Wholesale device registration system 106 prompts user for subscriber account authentication credentials (to be compared to subscriber credential data 152 for validity).

Process (c): Wholesale device registration system 106 authenticates user.

Process (d): Wholesale device registration system 106 initiates association of the wholesale device 160 with that subscriber's account (e.g., via the subscriber account system 184).

### EXAMPLE 3

Process (a): User goes to service provider web site and requests to register a wholesale device 160.

Process (b): Wholesale device registration system 106 prompts user for wholesale device type. In this case, wholesale device 160 capabilities are limited as such: the device is capable of only one-way messaging.

Process (c): Wholesale device registration system 106 prompts user for subscriber account authentication credentials (to be compared to subscriber credential data 152 at e.g., subscriber credential system 182, for validity) and initiating device capabilities (other device data 154) indicating the capabilities of the web enabled initiating device.

Process (d): Wholesale device registration system 106 authenticates user.

Process (e): Wholesale device registration system 106 generates a unique registration code.

Process (f): Wholesale device registration system 106 provides directions that the user should use the wholesale device 160 to send the unique registration code to a specified messaging destination.

Process (g): Wholesale device registration system 106 monitors incoming messages for message with the unique registration code. User responds with a registration code message using wholesale device 160.

Process (c): Once message with the unique registration code is received, wholesale device registration system 106 notifies a subscriber account system 184 (e.g., at service provider network 180 and/or wholesale device registration system 106) of new association between the wholesale device 160 and the subscriber's account.

### EXAMPLE 4

Process (a): Registration request initiated from a device with service provider relationship (e.g., other device 170, such as a smart phone).

Process (b): Wholesale device registration system 106 prompts user for wholesale device type and initiating device capabilities (other device data 154). In this case, wholesale device 160 capabilities are limited as such: the device does not have input, messaging or display capabilities.

Process (c): Wholesale device registration system 106 provides directions that the user should power-cycle the wholesale device 160.

Process (d): Wholesale device registration system 106 monitors network registration events from the same network location as the initiated device (other device 170), looking for one matching the type of the wholesale device 160 in a certain period of time.

Process (e): Once wholesale device 160 is discovered, wholesale device registration system 106 notifies a subscriber account system 184 (e.g., at service provider network 180 and/or wholesale device registration system 106) of new association between the wholesale device 160 and the subscriber's account.

In this case, the wholesale device registration system 106 could monitor for a SIP REGISTER event coming from the same cell tower as the initiated device (other device 170). In this case, wholesale device registration system 106 could then query both devices (160, 170) for a more exact location (using cell triangulation, GPS) to ensure the wholesale device 160 is physically near the other device 170 (initiating device). If multiple other devices (170) match, then wholesale device registration system 106 could request the user to power-cycle the wholesale device 160 again. This time only the subset of devices identified from round 1 are monitored for network registration events.

### EXAMPLE 5

Process (a): User goes to service provider web site and requests to register a wholesale device 160.

Process (b): Wholesale device registration system 106 prompts user for wholesale device type and initiating device capabilities (other device data 154, which may indicate initiating device is another device 170 such as a digital picture frame).

Process (c): Wholesale device registration system 106 prompts user for subscriber account authentication credentials (to be compared to subscriber credential data 152 for validity).

Process (d): Wholesale device registration system 106 authenticates user.

Process (e): Wholesale device registration system 106 prompts user for the address to send pictures to the wholesale device 160.

Process (f): Wholesale device registration system 106 selects an image (e.g., a photo from a photo library) and sends it to the wholesale device 160.

Process (g): Wholesale device registration system 106 prompts user to select (e.g., from a list) what type of photo was sent to the wholesale device 160.

Process (h): When user selects the correct type of photo, wholesale device registration system 106 notifies subscriber account system 184 (e.g., at service provider network 180 and/or wholesale device registration system 106) of new association between the wholesale device 160 and the subscriber's account.

As discussed herein, various systems and components are described as “obtaining” data (e.g., subscriber credential data 150, wholesale device data 152, other device data 154 is obtained/received into the system 102, etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing flowchart and block diagram drawings in the Figures illustrate the architecture, functionality, and operation of possible implementations of systems, methods and computer program products according to various several embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computerized wholesale device registration system comprising:
a registration framework for:
obtaining a wholesale device initiation request including:
identification of an initiating device; and
wholesale device identification information;
querying a device database to determine capabilities of the initiating device;
selecting a registration completion plug-in based upon the initiation request and the capabilities of the initiating device; and
initiating the registration completion plug-in to register the wholesale device with a subscriber account system.

2. The system of claim 1, further comprising:
a registration initiation plug-in for:
receiving the wholesale device initiation request from the initiating device;
determining whether the initiating device is the wholesale device or another registration device; and
requesting the wholesale device identification information in the case that the initiating device is the another registration device.

3. The system of claim 1, wherein the registration completion plug-in further performs the following:
authenticates the wholesale device and a subscriber associated with the wholesale device; and
provides authentication information to the registration framework.

4. The system of claim 1, further comprising a subscriber credential system for authenticating an existing subscriber.

5. The system of claim 1, further comprising a subscriber account system including links between subscribers and devices.

6. The system of claim 1, wherein the wholesale device includes an electronic reader, a smart utility meter, or a digital picture frame.

7. A method for registering a wholesale device to a service provider subscriber account, the method comprising:
receiving a request for registration of a wholesale device from an initiating device;
determining whether the initiating device is the wholesale device or another registration device;
requesting wholesale device identification information in the case that the initiating device is the another registration device;
determining capabilities of the initiating device using a wholesale device database or a direct device database; and
authenticating the wholesale device and a subscriber associated with the wholesale device using the wholesale device identification information and the capabilities of the initiating device.

8. The method of claim 7, wherein the determining of the capabilities of the initiating device is performed using the wholesale device database in the case that the initiating device is the wholesale device.

9. The method of claim 7, wherein the determining of the capabilities of the initiating device is performed using the direct device database in the case that the initiating device is the another registration device.

10. The method of claim 7, wherein the another registration device comprises:
an existing subscriber device including a smart phone, a netbook or a messaging phone;
a non-subscriber web-based device; or
an intermediary device including: an interactive voice response system, a voice-over internet protocol system, or a customer service request system.

11. The method of claim 7, wherein the initiating device is the another registration device, and the wholesale device includes a device without display capabilities, the method further comprising:
providing instructions to the another registration device to power cycle the wholesale device; and
monitoring a network connected to the another registration device and the wholesale device for a power cycle event associated with the wholesale device.

12. The method of claim 7, further comprising authenticating the subscriber associated with the wholesale device using subscriber credential data.

13. The method of claim 7, further comprising communicating an authentication message to the service provider after the authenticating.

14. A computer program comprising program code embodied in at least one computer readable storage medium, which when executed, enables a computer system to implement a method for registering a wholesale device to a service provider subscriber account, the method comprising:
receiving a request for registration of a wholesale device from an initiating device;
determining whether the initiating device is the wholesale device or another registration device;
requesting wholesale device identification information in the case that the initiating device is the another registration device;
determining capabilities of the initiating device using a wholesale device database or a direct device database; and
authenticating the wholesale device and a subscriber associated with the wholesale device using the wholesale device identification information and the capabilities of the initiating device.

15. The computer program of claim 14, wherein the determining of the capabilities of the initiating device is performed using the wholesale device database in the case that the initiating device is the wholesale device.

16. The computer program of claim 14, wherein the determining of the capabilities of the initiating device is performed using the direct device database in the case that the initiating device is the another registration device.

17. The computer program of claim 14, wherein the another registration device comprises:
an existing subscriber device including a smart phone, a netbook or a messaging phone;
a non-subscriber web-based device; or
an intermediary device including: an interactive voice response system, a voice-over internet protocol system, or a customer service request system.

18. The computer program of claim 14, wherein the initiating device is the another registration device, and the wholesale device includes a device with display only capabilities, the method further comprising:
providing an image to be displayed at the wholesale device; and
querying the another registration device for information identifying the image.

19. The computer program of claim 14, the method further comprising authenticating the wholesale device and the subscriber associated with the wholesale device using subscriber credential data.

20. The computer program of claim 14, the method further comprising communicating an authentication message to the service provider after the authenticating.
